(19) United States
(12) Patent Application Publication
(10) Pub. No.: US 2026/0267912 A1
(43) Pub. Date: Sep. 10, 2026

(54) AUTOMATED VECTOR DATABASE WITH ENHANCED SEMANTIC AUGMENTATION

(71) Applicant: Robert Bosch GmbH, Stuttgart (DE)

(72) Inventor: PONGTEP ANGKITITRAKUL, Dublin, CA (US)

(21) Appl. No.: 19/073,165

(22) Filed: Mar. 7, 2025

(51) Int. Cl. G06F 16/63; G06F 16/22; G06F 16/61

(52) U.S. Cl. CPC G06F 16/63; G06F 16/2237; G06F 16/61

(57) ABSTRACT

A digital audio signal is segmented into a plurality of discrete time-based chunks of predefined length. Features are extracted from each chunk to generate corresponding audio embeddings defined as vector representations of the digital audio signal. The audio embeddings are stored in a vector database for retrieval and similarity-based search. The audio embeddings are processed using an audio-language model guided by structured prompts of an insights template to generate characteristic metadata associated with corresponding time-based chunks of the digital audio signal. The metadata is stored in a relational database, wherein the audio embeddings are indexed by shared identifiers and the metadata is linked to the audio embeddings using the shared identifiers. A multimodal similarity-based search is performed to locate chunks of the digital audio signal based on a combination of vector-based similarity scores from the vector database and keyword-based ranking of the metadata in the relational database.

### TECHNICAL FIELD

Aspects of the disclosure generally relate to an automated vector database with enhanced semantic augmentation.

### BACKGROUND

Embeddings refer to numerical representations of data such as text, images, or audio. In many examples, embeddings are computed such that where similar items are positioned close together numerically. This allows machine learning models to understand the relationships between different pieces of data. A vector database is a collection of data that stores information as mathematical representations, or vectors. Vector databases are used to store, manage, and index high-dimensional data, such as embeddings.

### SUMMARY

In one or more illustrative examples, a method for searching enhanced semantic representations of audio data includes segmenting a digital audio signal into a plurality of discrete time-based chunks of predefined length; extracting features from each chunk to generate corresponding audio embeddings defined as vector representations of the digital audio signal; storing the audio embeddings in a vector database for retrieval and similarity-based search; processing the audio embeddings using an audio-language model guided by structured prompts of an insights template to generate characteristic metadata associated with corresponding time-based chunks of the digital audio signal; storing the metadata in a relational database, wherein the audio embeddings are indexed by shared identifiers and the metadata is linked to the audio embeddings using the shared identifiers; and performing a multimodal similarity-based search to locate chunks of the digital audio signal based on a combination of vector-based similarity scores from the vector database and keyword-based ranking of the metadata in the relational database.

In one or more illustrative examples, the method further includes receiving the audio signal comprising a sequence of audio samples; and preprocessing the audio signal, including one or more of normalizing signal levels, resampling to a target rate, and trimming silences.

In one or more illustrative examples, the audio embeddings represent characteristics of the audio signal including at least one of pitch, tempo, spectral content, loudness, or background noise.

In one or more illustrative examples, the audio vectorization comprises applying one or more of Mel-Frequency Cepstral Coefficient (MFCC) extraction, a pretrained machine learning model for feature extraction, or spectrogram-based transformation including short-time Fourier transform (STFT) or Mel spectrogram.

In one or more illustrative examples, the audio-language model is trained on multimodal data and configured to analyze and classify non-verbal sounds, including environmental noises and machine sounds.

In one or more illustrative examples, the metadata generated by the audio-language model include at least one of classification of sound type, detection of periodic noise patterns, identification of anomalies based on deviations from expected embeddings, or environmental context interpretation.

In one or more illustrative examples, the method further includes using a soft prompt mechanism to prompt the audio-language model to incorporate high-level semantic evidence using event tags, such that the metadata includes the event tags matching the audio embeddings.

In one or more illustrative examples, the method further includes receiving a query including audio and keywords; querying the vector database based on semantic similarity of the audio to determine matching results; refining the results by querying the relational database based on the keywords; and returning search results based on a combination of vector-based similarity scores and keyword-based ranking.

In one or more illustrative examples, the method further includes performing an anomaly detection by computing a similarity score between an input audio received from a manufacturing system and reference embeddings in the vector database; determining a deviation threshold based on statistical measures of the reference embeddings; classifying the input audio as anomalous if the similarity score falls outside the deviation threshold; and controlling an actuator responsive to the input audio being classified as anomalous.

In one or more illustrative examples, a system for searching enhanced semantic representations of audio data includes a vector database; a relational database; and one or more computing devices configured to segment a digital audio signal into a plurality of discrete time-based chunks of predefined length, extract features from each chunk to generate corresponding audio embeddings defined as vector representations of the digital audio signal, store the audio embeddings in a vector database for retrieval and similarity-based search, process the audio embeddings using an audio-language model guided by structured prompts of an insights template to generate characteristic metadata associated with corresponding time-based chunks of the digital audio signal, store the metadata in a relational database, wherein the audio embeddings are indexed by shared identifiers and the metadata is linked to the audio embeddings using the shared identifiers, and perform a multimodal similarity-based search to locate chunks of the digital audio signal based on a combination of vector-based similarity scores from the vector database and keyword-based ranking of the metadata in the relational database.

In one or more illustrative examples, the one or more computing devices are further configured to receive the audio signal comprising a sequence of audio samples; and preprocess the audio signal, including one or more of normalizing signal levels, resampling to a target rate, and trimming silences.

In one or more illustrative examples, the audio embeddings represent characteristics of the audio signal including at least one of pitch, tempo, spectral content, loudness, or background noise.

In one or more illustrative examples, the one or more computing devices are further configured to apply one or more of MFCC extraction, a pretrained machine learning model for feature extraction, or spectrogram-based transformation including STFT or Mel spectrogram.

In one or more illustrative examples, the audio-language model is trained on multimodal data and configured to analyze and classify non-verbal sounds, including environmental noises and machine sounds.

In one or more illustrative examples, the metadata generated by the audio-language model include at least one of classification of sound type, detection of periodic noise patterns, identification of anomalies based on deviations from expected embeddings, or environmental context interpretation.

In one or more illustrative examples, the one or more computing devices are further configured to use a soft prompt mechanism to prompt the audio-language model to incorporate high-level semantic evidence using event tags, such that the metadata includes the event tags matching the audio embeddings.

In one or more illustrative examples, the one or more computing devices are further configured to receive a query including audio and keywords; query the vector database based on semantic similarity of the audio to determine matching results; refine the results by querying the relational database based on the keywords; and return search results based on a combination of vector-based similarity scores and keyword-based ranking.

In one or more illustrative examples, wherein the one or more computing devices are further configured to perform an anomaly detection including to compute a similarity score between an input audio received from a manufacturing system and reference embeddings in the vector database; determine a deviation threshold based on statistical measures of the reference embeddings; classify the input audio as anomalous if the similarity score falls outside the deviation threshold; and control an actuator responsive to the input audio being classified as anomalous.

In one or more illustrative examples, a non-transitory computer-readable medium includes instructions that, when executed by one or more computing devices, cause the one or more computing devices to perform operations including to segment an audio signal into discrete time-based chunks of predefined length; extract features from each chunk using audio vectorization to generate corresponding audio embeddings; store the audio embeddings in a vector database for retrieval and similarity-based search; process the audio embeddings using an audio-language model guided by structured prompts of an insights template to generate metadata associated with a corresponding time-based chunk of the audio signal; and store the metadata in a relational database, wherein the audio embeddings are indexed by shared identifiers and the metadata is linked to the audio embeddings using the shared identifiers.

In one or more illustrative examples, the non-transitory computer-readable medium further includes instructions that when executed by the one or more computing devices, cause the one or more computing devices to perform operations including to receive a query including audio and keywords; query the vector database based on semantic similarity of the audio to determine matching results; refine the results by querying the relational database based on the keywords; and return search results based on a combination of vector-based similarity scores and keyword-based ranking.

In one or more illustrative examples, the non-transitory computer-readable medium further includes instructions that when executed by the one or more computing devices, cause the one or more computing devices to perform operations including to compute a similarity score between an input audio received from a manufacturing system and reference embeddings in the vector database; determine a deviation threshold based on statistical measures of the reference embeddings; classify the input audio as anomalous if the similarity score falls outside the deviation threshold; and control an actuator responsive to the input audio being classified as anomalous.

### BRIEF DESCRIPTION OF THE DRAWINGS

FIG. 1 illustrates an example system for providing an automated vector database with enhanced semantic augmentation;

FIG. 2 illustrates an example process for implementing an automated vector database with enhanced semantic augmentation;

FIG. 3 illustrates an example client-server architecture using the framework to implement a query user interface;

FIG. 4 illustrates an example application of the framework by a control system for controlling a computer-controlled machine; and

FIG. 5 illustrates an example manufacturing system implementing the framework for use in anomaly detection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In audio analysis and retrieval, metadata may provide a broad description of an entire clip. However, such an approach may fail to capture the nuances of specific segments within the audio. For instance, a minute-long recording may be labeled as containing a key event, yet that key event may only occur during a few seconds of the recording. In another example, a pop music track may have parts that include rap segments, which may be inconsistent with an overall labeling of the audio as pop.

Approaches where the overall clip is described may limit the precision of semantic understanding, which in turn may reduce the ability for a system to accurately classify, search, and retrieve meaningful information from the audio. With the growing complexity and volume of audio data, there is a need for more granular, automated methods of extracting and applying audio characteristics to improve the interpretability and functionality of audio sample retrieval through use of vector databases.

An automated semantic generation framework is disclosed that separates audio into smaller chunks of predefined length, extracting detailed characteristics from each segment. This method improves the quality of metadata and enhances vector-based search systems by providing more accurate and context-aware representations of audio data. Moreover, by reducing reliance on manual annotation, the framework offers scalability for applications such as real-time diagnostics and predictive maintenance.

The disclosed framework also enables hybrid search methods that combine vector-based semantic search with keyword-based techniques to produce more relevant results. By linking audio vectors with contextual metadata, the system can adjust similarity scores based on environmental or operational context, improving anomaly detection. For example, a sound that might be considered anomalous in one context could be entirely normal in another, depending on the metadata. Additionally, context-weighted similarity metrics are used to refine the detection of anomalies, ensuring that both audio content and surrounding conditions are taken into account. This provides a more adaptable and precise tool for applications where understanding subtle variations in audio is helpful, such as in industrial monitoring or content indexing.

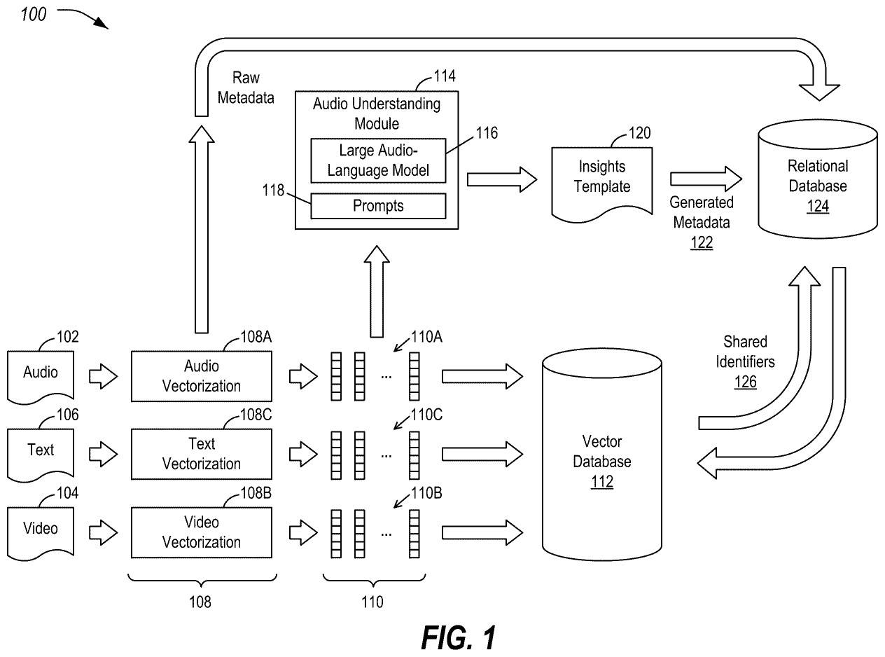

FIG. 1 illustrates an example framework system 100 for providing an automated vector database with enhanced semantic augmentation. As shown, the framework system 100 receives inputs such as audio signals 102, video signals 104, and text input 106. A vectorization 108 is performed on the inputs to generate embeddings 110 (e.g., audio embeddings 110A, video embeddings 110B, and textual embeddings 110C). The embeddings 110 are stored in a vector database 112. An audio understanding module 114 uses a large audio-language model 116 and prompts 118 to generate insights templates 120 from the embeddings 110. These insights templates 120 are added as generated metadata 122 to a relational database 124. Shared identifiers 126 between the relational database 124 and the vector database 112 may be used to facilitate querying to provide results based on keyword. It should be noted that the components illustrated in the framework system 100 are only an example modularization, and more, fewer, and differently arranged components may be used and executed by one or more of various computing devices.

The audio signals 102 refer to computer-readable digital sound files representing various captured and/or simulated acoustic content. The audio files may include an ordered sequence of samples that when converted into audio by a speaker or other sound reproduction device, reproduce the acoustic content into the environment. The samples of the audio signals 102 may be encoded with various encodings, bit rates, sampling rates, etc. The audio signals 102 may include spoken language, environmental noises, music, or machinery sounds. The audio signals 102 may be captured and processed to extract meaningful information for various applications.

The audio signals 102 may be collected and preprocessed for use by the framework system 100. In an example, the audio signals 102 may be gathered audio files. The audio files may be associated with metadata (such as acoustic classes, operational states, machines, time stamps, etc.) In some cases, the audio signals 102 may be preprocessed by normalizing signals, resampling to a common rate (e.g., 16 kHz), and/or trimming silences.

The video signals 104 refer to computer-readable sound files representing various captured and/or simulated visual content. The video signals 104 may include an ordered sequence of still image frames at a frame rate (e.g., 24 frames per second, 30 frames per second, 60 frames per second, etc.) that when displayed by a screen, reproduce the visual content into the environment. The frames of the video signals 104 include pixel data formed at various resolutions (e.g., standard definition (SD), high definition (HD), full-HD, ultra-high definition (UHD), 4K, etc.), dynamic range (8 bits, 10 bits, or 12 bits per pixel per color, etc.), and frequencies and count of color channels (e.g., infrared, red-green-blue (RGB), black & white, etc.). In some examples, the audio signals 102 and the video signals 104 may be stored in a common file, and/or may be captured and/or reproduced together to form a multimodal audio/video presentation.

The text input 106 refers to written or transcribed human language, which may be formatted digitally for processing and analysis. The text input 106 may be paired with the other data modalities such as the audio signals 102 and/or the video signals 104 to provide richer semantic understanding and context. For example, the text input 106 may include textual data descriptive of the audio content and/or the video content, such as a written version of spoken text, and/or text descriptive of the audio and/or video itself.

Vectorization 108 refers to a process of transforming the input signals into high-dimensional vector representations of data referred to as embeddings 110. These embeddings 110 may be created through machine learning (ML) models to capture the semantic or contextual information of various data types such as text, images, and audio. The embeddings 110 may enable efficient analysis, similarity searches, and classification of the input signals.

Audio vectorization 108A refers to a process of transforming the audio signals 102 into audio embeddings 110A. The audio embeddings 110A may refer to numerical vector representations that capture key characteristics of the underlying sounds represented by the audio signals 102, such as pitch, tempo, and spectral content. In an example, the features may be extracted by classical Mel-Frequency Cepstral Coefficients (MFCCS) extraction. In another example, a pretrained model may be used to perform the audio vectorization 108A, such as Wav2Vec, OpenL3, or Contrastive Language-Audio Pretraining (CLAP). In yet another example, a spectrogram-based vectorization 108 may be performed, such as using an approach such as short-time Fourier transform (STFT), Mel spectrogram, or wavelet transform. These audio embeddings 110A may provide condensed representations of key attributes of the audio signals 102. In some examples, reduction techniques such as principal component analysis (PCA) may also be employed to optimize performance

The audio vectorization 108A may segment the audio signals 102 into smaller, equal-length chunks of predefined length (e.g., 5-second intervals). Each chunk may then be analyzed, and its unique features may be extracted and represented as a vector for the audio embeddings 110A. These audio embeddings 110A may define various audio characteristics that correspond to the time window of the respective chunk, enabling more precise analysis and retrieval.

Video vectorization 108B refers to a process of transforming the video signals 104 into video embeddings 110B. The video embeddings 110B may refer to numerical vector representations that capture key characteristics of the underlying video represented by the video signals 104. In an example, a pretrained model may be used to perform the audio vectorization 108A, such as ResNet or a Visual Geometry Group (VGG) convolutional network, to extract spatial features from individual frames. In another example, temporal dependencies may be computed by processing sequential frame features.

Textual vectorization 108C refers to a process of transforming the text input 106 into textual embeddings 110C. The textual embeddings 110C may refer to numerical vector representations that capture key characteristics of the underlying text represented by the text input 106. In an example, a pretrained model may be used to perform the textual vectorization 108C, such as Word2Vec, Universal Sentence Encoder (USE), or SBERT (Sentence-BERT), to extract semantic meaning from the text input 106.

The vector database 112 refers to a computing device or devices designed to store, manage, and retrieve the embeddings 110. The vector database 112 may specialize in handling large volumes of high-dimensional vectors and enable efficient similarity searches. The vector database 112 may be configured to perform similarity search on the embeddings 110, where the goal is to find data points that are close to a given query vector based on specific distance metrics such as Euclidean distance or cosine similarity. To do so, the vector database 112 indexes and supports the querying of large-scale vector data. Advanced indexing techniques may be employed to expedite similarity searches while balancing accuracy and speed. These techniques may include, as some non-limiting examples, KD-trees, Ball-trees, and Approximate Nearest Neighbor (ANN) algorithms like FAISS (Facebook AI Similarity Search) and Spotify's Annoy. In some examples, the vector database 112 may be scaled horizontally to manage vectors across distributed nodes with minimal latency. The vector database 112 may integrate with machine learning workflows, enabling dynamic updates and real-time processing of embeddings 110. As a result, the vector database 112 may be utilized in recommendations, audio, image and text retrieval, and various natural language processing (NLP) tasks.

In some implementations, the vector database 112 may be configured to use Faiss, an open-source C++ library for vector similarity search, in combination with the Milvus open-source vector data management software to efficiently store and search large-scale and dynamic vector data. The vectors may also be indexed for efficient retrieval. Indexing involves organizing the vectors into the database using algorithms such as Hierarchical Navigable Small Worlds (HNSW) for approximate nearest neighbor searches.

The audio understanding module 114 may make use of the large audio-language model 116 and prompts 118 to fill out insights templates 120 from the embeddings 110. In particular, the vectors of each chunk of the audio embeddings 110A may be passed to the audio understanding module 114 to extract various information to be included in the insights template 120.

The large audio-language model 116 may be any of various ML models built using transformer architectures (such as Generative Pre-trained Transformer (GPT) or Bidirectional Encoder Representations from Transformer (BERT) models), that are trained on massive datasets. The large audio-language model 116 may be used to analyze and comprehend audio beyond simple transcription, such as identifying speaker intent, emotions, or specific audio events. The large audio-language model 116 may be used to perform tasks such as speech recognition, multi-lingual transcription, and contextual audio understanding. This ability may facilitate applications such as voice assistants, automated transcription, anomaly detection in industrial settings, and advanced audio analytics.

In many examples, the large audio-language model 116 is trained on multimodal data, such as both audio and text, to learn relationships between sound and meaning. This allows the large audio-language model 116 to combines the capabilities of NLP and audio processing, allowing for a deeper understanding of spoken language and audio content. An example large audio-language model 116 is the OpenAI Whisper model.

The audio understanding module 114 is configured to use the large audio-language model 116 to interpret complex non-speech and non-verbal sounds in the audio embeddings 110A. This may significantly extend the capabilities of the system. Instead of focusing on speech transcription or voice recognition, the audio understanding module 114 may target environmental sounds, machinery noise, and other non-verbal auditory inputs in the audio embeddings 110A. This allows the audio understanding module 114 to extract insights from the soundscapes with greater depth and precision.

The audio understanding module 114 may use a soft prompt 118 mechanism, which allows the large audio-language model 116 to incorporate high-level semantic evidence using event tags from the audio signals 102. Soft prompting refers to the use of small binary files that when included in the prompt 118 can adjust the behavior and biases of the model. Soft prompts are learnable continuous embeddings that replace traditional discrete text prompts to guide language models. Instead of modifying the model's weights through full fine-tuning, soft prompt tuning optimizes only a small set of additional parameters inserted into the input space. These learnable prompt vectors are trained via gradient descent, allowing large-scale models to adapt efficiently to different tasks with minimal computational cost.

The event tags provide the large audio-language model 116 with contextual clues that help the large audio-language model 116 to infer a deeper understanding of the sounds it processes. For example, by recognizing tags such as “engine noise” or “rain,” the large audio-language model 116 may perform more advanced reasoning about the environment in which the audio signals 102 was recorded. This improves the understanding of the large audio-language model 116 of individual sounds within the audio signals 102 and also enhances the ability of the large audio-language model 116 to detect patterns and relationships between the sounds, improving semantic reasoning.

In one implementation, the audio understanding module 114 is used to automatically extract specific audio characteristics using targeted prompts 118. The prompts 118 may be used to guide the large audio-language model 116 to focus on attributes relevant to a given use case. These prompts 118 allow the large audio-language model 116 to generate detailed outputs, making it adaptable to a wide range of applications.

Insights templates 120 may be designed for generating insights based on the type of audio analysis desired. Each insights template 120 may include a set of prompts 118 that, when provided to the large audio-language model 116 in combination with the audio embeddings 110A, cause the large audio-language model 116 to provide results that can be included as generated metadata 122 for inclusion in a relational database 124.

One of the key insights generated by the audio understanding module 114 is a general understanding of the audio content. For example, a prompt 118 such as “Describe the main characteristics of this audio recording” may guide the large audio-language model 116 to analyze and provide a broad overview of the audio, including identifying sound sources, differentiating between human-made and machine-related sounds, and classifying mixed soundscapes. The large audio-language model 116 may also describe the overall context, such as background noise or environmental factors like wind or outdoor conditions. A more specific prompt 118, such as “Analyze the contextual elements of this audio recording and describe any relevant environmental or situational factors,” may be applied to the large audio-language model 116 to provide additional insights into dynamic shifts in the audio environment, which might be helpful in fields such as environmental monitoring or sound design.

To focus on specific technical characteristics, the prompts 118 may be designed to extract various specific audio features such as pitch, tempo, spectral content, and loudness. For example, the prompt 118 “Identify the pitch and tempo of this audio clip” may be used to extract musical elements, while a more detailed prompt 118 such as “Rate the loudness level on a scale from 1 to 10, where 1 represents quiet and 10 represents extremely loud” may provide a scalable measure of sound intensity. These types of prompts 118 may produce the structured outputs of the insights template 120. The insights template 120 may accordingly provide insights for various tasks such as music production, acoustic engineering, or user experience testing in audio interfaces.

The large audio-language model 116 may also be provided prompts 118 to detect and describe temporal or behavioral patterns in the audio embeddings 110A. For instance, a prompt 118 such as “Identify any periodic noises or sudden stops in this recording” may guide the large audio-language model 116 to focus on changes in temporal structure, which could be valuable in industrial settings for identifying machinery anomalies. Similarly, a prompt 118 such as “Analyze repetitive behavioral patterns in this recording” may be used to detect recurring sound patterns, useful in monitoring systems or security applications.

For more human-centered use cases, the large audio-language model 116 may be prompted to detect emotional tone or mood from speech. A prompt 118 such as “Describe the emotional tone of the speaker in this audio clip” may direct the large audio-language model 116 to analyze voice characteristics such as intonation, cadence, and pitch variation, which can be used to infer the speaker's emotional state. This type of analysis could be helpful in customer service scenarios, therapy sessions, or content creation where emotional context is useful.

One simple prompt 118 can be done for comparative analysis, such as compare this audio recording to a typical sound expected from the [xxx] sound, and highlight any difference in characteristics such as pitch, rhythm, etc.

An example insights template 120 is shown in Table 1, which may be used to extract insights for different characteristics:

| Characteristics | Insights |
|---|---|
| Pitch | sudden shifts, steady/jitter, high-pitched, unusual harmonic, cyclic |
| | pattern |
| Tempo/Rhythm | sudden changes, rhythmic cycles, out of sync, off beat, pulsing |
| Loudness | sudden drop, lower sound level, increased loudness, fluctuation, |
| | noise spike |
| Frequency Distribution | shift in frequency peak, distorted harmonic, broadband noise, energy |
| | concentration, spectral imbalance, high/low-frequency content |
| Spectral Content | harmonic distortion, missing spectral component, spectral |
| | imbalance, broadening peaks, deviation from baseline |
| Background Noise | Elevated noise floor, noise type, unexpected noise, noise masking, |
| | noise sources |
| Environment Context | Indoor/outdoor, room acoustics, environmental conditions |
| (Speech) Emotion | Emotional states, pitch/intonation, timbre, rhythm |

The insights that are generated using the prompts 118 of the insights template 120 may be associated with the audio embeddings 110A of the audio chunk as generated metadata 122. The relational database 124 may be updated to store the generated metadata 122 for each audio chunk audio embeddings 110A, along with any original raw metadata collected during data acquisition or human annotation.

A common identifier, such as “audio_chunk_id”, may be used to link entries in both the relational database 124 (containing the metadata 122) and the vector database 112 (storing the feature vectors). This common identifier between the vector database 112 and the relational database 124 may be referred to as a shared identifier 126. This allows for a seamless integration and retrieval across both the vector database 112 and the relational database 124.

The framework system 100 may enable hybrid search capabilities, such as combining vector search with keyword boosting. This allows for more accurate results, including identifying all audio signals 102 related to a concept (e.g., a grinding machine, for example) by leveraging both semantic similarity and keyword relevance.

The query execution is also enhanced in this framework system 100. In one implementation, query planners select clusters of records based on their similarity to the sense vector of the query. The query executors then compare the vector database 112 and relational database 124, selecting results based on their similarity across multiple representations. This hybrid approach of using both keyword-based and semantic-based querying can affect accuracy, particularly when the vectors come from different data representations, but it allows for more flexible and sophisticated searches.

To ensure the framework system 100 stays up-to-date, an automated understanding and template framework may be deployed. This framework can enable real-time updates to vectors, indices, and relationships, ensuring that the framework system 100 can adapt to new data inputs quickly. As a result, the audio understanding module 114 may continually refine its performance, offering timely, accurate, and context-aware insights in dynamic environments.

In one implementation, the proposed vector database 112 is applied for anomaly detection by identifying vectors that deviate from expected clusters, combining vector representations and semantic insights to enhance search accuracy across various contexts. The vector database 112 may provide an efficient means of storing and querying data, allowing users to analyze patterns and detect anomalies with precision. Anomalous vectors may be identified by setting threshold values, such as a 4-standard deviation span from the mean of all vectors, with vectors falling outside this range being flagged as anomalies. Hybrid conditions can also be applied, integrating both vector similarity and semantic criteria, ensuring that only vectors meeting all conditions are classified as anomalous. This approach improves detection flexibility and performance across diverse applications. For example, a sound considered anomalous in one context might be normal in another. In some implementations, a context-weighted similarity metric may be used to adjust vector distances based on metadata 122 indicates a specific operational mode.

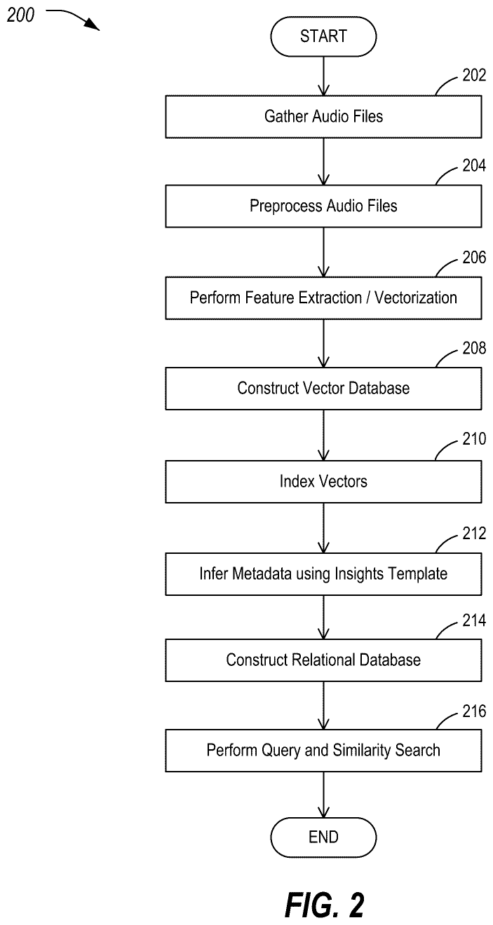

FIG. 2 illustrates an example process 200 for implementing an automated vector database 112 with enhanced semantic augmentation. In an example, the process 200 may be performed by the framework system 100.

At operation 202, the framework system 100 gathers audio signals 102. In an example, the audio signals 102 may include various captured and/or simulated acoustic content such as spoken language, environmental noises, music, or machinery sounds. The audio signals 102 may be gathered from different sources and may be associated with metadata such as acoustic classes, operational states, machine identifiers, and time stamps.

At operation 204, the framework system 100 preprocesses the audio signals 102. In an example, the preprocessing may involve normalizing the audio signals 102, resampling them to a common rate (e.g., 16 kHz), trimming silences, and/or enhancing the quality of the signal. Preprocessing ensures that the audio signals 102 are in a format suitable for downstream processing, enabling more consistent and accurate feature extraction.

At operation 206, the framework system 100 performs feature extraction and vectorization 108. In an example, the framework system 100 applies audio vectorization 108A to convert the audio signals 102 into the audio embeddings 110A. The audio embeddings 110A may capture key characteristics of the audio, such as pitch, tempo, spectral content, and other distinguishing audio features. Feature extraction may be performed using various techniques such as Mel-Frequency Cepstral Coefficients (MFCCs), pretrained models like Wav2Vec or OpenL3, or spectrogram-based transformations such as STFT or Mel spectrogram. The audio vectorization 108A may segment the audio signals 102 into smaller, equal-length chunks (e.g., 5-second intervals), enabling finer-grained analysis.

At operation 208, the framework system 100 constructs the vector database 112. In an example, the vector database 112 stores the audio embeddings 110A determined at operation 206. In some examples, the vector database 112 further includes other corresponding information, such as video embeddings 110B and/or textual embeddings 110C corresponding to the same timing as the audio embeddings 110A.

At operation 210, the framework system 100 indexes the vectors in the vector database 112. In an example, indexing algorithms such as HNSW may be used to facilitate fast approximate nearest neighbor searches.

At operation 212, the framework system 100 infers the metadata 122 using the audio understanding module 114 and an insights template 120. In an example, the audio embeddings 110A of each audio chunk may be processed by the large audio-language model 116, which may be guided by soft prompts 118 and event tags to extract relevant insights. The insights template 120 structures the generated metadata 122, categorizing characteristics such as pitch variation, loudness fluctuations, frequency shifts, background noise, and/or environmental context. The insights template 120 that is used may be chosen based on content, environment, etc. of the audio signals 102.

As operation 214, the framework system 100 constructs the relational database 124. In an example, the relational database 124 stores the generated metadata 122, linking it to the corresponding audio embeddings 110A using a shared identifier 126, such as audio_chunk_id. This allows the metadata 122 to be accessed and queried alongside the audio embeddings 110A, facilitating hybrid search capabilities that combine keyword-based and vector-based search methods.

At operation 216, the framework system 100 performs queries of the vector database 112. In an example, the queries may be executed using a combination of similarity-based retrieval from the vector database 112 and keyword-based filtering from the relational database 124. This may allow for hybrid search capabilities that enable more relevant results by adjusting similarity scores based on contextual metadata. Additionally, queries may be optimized through query planning mechanisms that select clusters of records based on their similarity to the sense vector of the query. The framework system 100 may also enable anomaly detection by identifying embeddings that deviate significantly from expected patterns, using threshold-based or context-weighted similarity metrics.

After operation 216, the process 200 ends. It should be noted that one or more operations of the process 200 may be performed in orderings other than as shown, may be repeated one or more times, may be omitted, and/or may be performed concurrent to one another.

The framework system 100 is adaptable to various downstream applications, including search and retrieval, generative machine learning tasks, and fine-tuning models for specific use cases. The framework system 100 may also be extended to different modalities by integrating the appropriate understanding modules, trained with joint embeddings of language and the target modality. This flexibility allows the framework system 100 to seamlessly support a wide range of applications, enhancing both its versatility and performance across diverse domains.

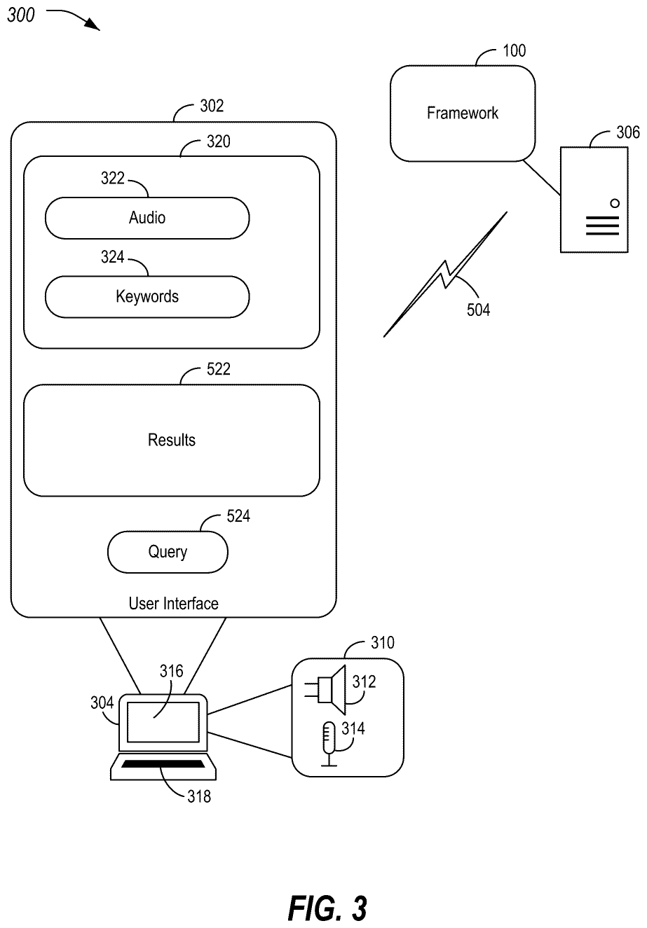

FIG. 3 illustrates an example client-server architecture 300 using the framework system 100 to implement a query user interface 302. The query user interface 302 may be executed by a client device 304 and may be configured to communicate with a server device 306 via a communication link 308. The client device 304 may include but is not limited to a laptop, a tablet, a smartphone, a smart watch or other wearable, and/or a desktop computer. Among other components, the client device 304 may include various components, such as an audio system 310 having a speaker 312 or other audio output device and/or a microphone 314 or other audio input device, a monitor 316 or other output device for displaying information such as the user interface 302, and/or a keyboard 318 or other input device for receiving user input.

The vector database 112 and/or the relational database 124 of the framework system 100 may be accessible via the user interface 302. The user interface 302 may include input controls 320 configured to receive information for which audio is to be queried. The input controls 320 may include an audio input 322 for conversion into embeddings 110 to be queried into the vector database 112 to receive matching results 522. In some examples, the audio input 322 may receive live audio from the microphone 314, while in other examples the audio input 322 allows for selection of previously recorded audio. The input controls 320 may also include a keywords control 324 configured to receive metadata for querying the relational database 124 to augment or narrow the results 522 based on the generated metadata 122. The user interface 302 may include a query control 524 that, when selected, provides the audio input 322 and/or keywords 324 to the server device 306 to query the vector database 112 and/or the relational database 124, such that the results 522 can be returned from the server device 306 for display by the client device 304.

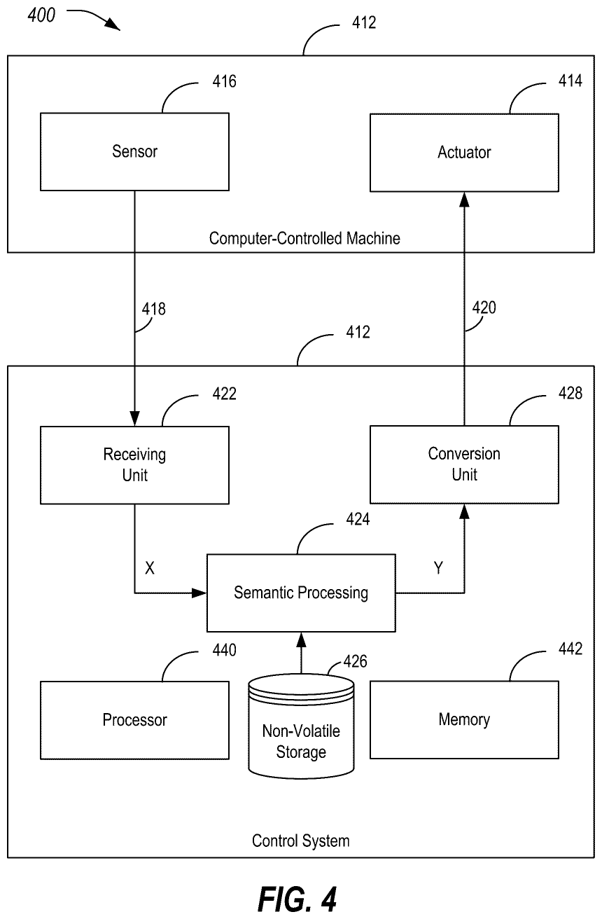

FIG. 4 illustrates an example application of the framework system 100 by a control system 412 for controlling a computer-controlled machine 402. The control system 412 may be configured to receive sensor signals 418 from one or more sensors 416, process the signals, and provide actuator control commands 420 to control one or more one or more actuators 414 in response. The computer-controlled machine 402 may include the one or more actuators 414 and one or more sensors 416. In other examples, the control system 412 may include one or more of the actuators 414 and/or the sensors 416.

The actuators 414 may be configured to control various aspects of the computer-controlled machine 402. As some nom-limiting examples, the actuators 414 may include one or more of a servo motor, a stepper motor, a linear actuator 414, a solenoid, a pneumatic actuator 414, a hydraulic actuator 414, a piezoelectric actuator 414, a voice coil actuator 414, etc.

The sensors 416 may be configured to sense conditions of the computer-controlled machine 402. The sensors 416 may be configured to encode the sensed condition into sensor signals 418 and to transmit sensor signals 418 to control system 412. Non-limiting examples of sensor 416 include microphones 314, accelerometers, and the like. In one embodiment, the sensor 416 is an audio sensor 416 configured to sense audio data of an environment proximate to computer-controlled machine 402.

The control system 412 includes a receiving unit 422 configured to receive the sensor signals 418 from the sensor 416 and to transform the sensor signals 418 into input signals X. In an alternative example, the sensor signals 418 may be received directly as input signals X without the receiving unit 422. Each input signal X may include at least a portion of each sensor signal 418. For example, the input signal X may include a chunk of audio data over time, e.g., of the chunk size used in creating the audio embeddings 110A. In such an example, each input signal X may include data corresponding to sound recorded by the sensors 416 for a discrete time period.

The control system 412 further includes semantic processing 424. The semantic processing 424 may be configured to analyze the input signal X to determine whether actions should be performed by the control system 412. In an example, the semantic processing 424 may include querying the vector database 112 using a similarity-based retrieval from the vector database 112 and/or keyword-based filtering from the relational database 124. Based on the querying, the control system 412 may determine output signals Y to control the one or more actuators 414.

The control system 412 further includes a conversion unit 428 that converts the output signals Y into actuator control commands 420. These actuator control commands 420 may then be provided to the actuators 414, which therefore actuate the computer-controlled machine 402 in response to actuator control commands 420. In other examples, the actuator 414 is configured to actuate computer-controlled machine 402 based directly on the output signals Y.

Upon receipt of the actuator control commands 420 by actuator 414, the actuator 414 is configured to execute an action to control the computer-controlled machine 402. For example, the actuator 414 may turn on or off one or more components, adjust one or more settings of the computer-controlled machine 402, etc. In some examples, the actuator control commands 420 may also be utilized to control a display to inform of the conditions and/or output signals Y identified by the semantic processing 424.

The control system 412 also includes one or more processors 440, memories 442, and non-volatile storage 426 to perform the operations of the receiving unit 422, the semantic processing 424, and the conversion unit 428.

The non-volatile storage 426 may include one or more persistent data storage devices such as a hard drive, optical drive, tape drive, non-volatile solid-state device, cloud storage or any other device capable of persistently storing information. The processor 440 may include one or more devices such as high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 442. The memory 442 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Upon execution by processor 440, the computer-executable instructions of non-volatile storage 426 may cause control system 412 to implement one or more of the ML algorithms and/or methodologies as disclosed herein. Non-volatile storage 426 may also include ML data (including data parameters) supporting the functions, features, and processes of the one or more embodiments described herein.

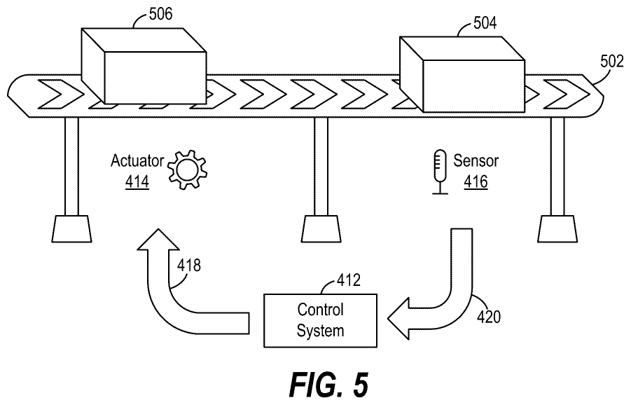

FIG. 5 illustrates an example manufacturing system 500 implementing the framework system 100 for use in anomaly detection. The manufacturing system 500 may be configured to control a manufacturing machine 802, such as a punch cutter, a cutter or a gun drill, etc., such as part of a production line.

The manufacturing system 500 may be configured to control an actuator 414, which is configured to control a manufacturing machine 502. An audio sensor 416 of the manufacturing system 500 may be configured to capture sound of the operation of the manufacturing machine 502 in producing a manufactured product 504. The semantic processing 424 may be configured to determine a state of the manufacturing machine 502 from the captured audio. An actuator 414 may be configured to control the manufacturing machine 502 depending on the determined state of the manufacturing machine 502 for a subsequent manufacturing of the manufactured product 804. In particular, the actuator 414 may be configured to control functions of the manufacturing machine 802 on subsequent manufactured product 806 of the manufacturing system 500 depending on the determined state of the manufacturing machine 502.

In another example, the framework system 100 may be used to explain reasons for potential issues in the manufacturing system 500. This may occur based on unusual sounds collected from the sensors 416. In another example, the framework system 100 may be used to predict next predicted outcomes that should be addressed based on the sounds collected from the sensors 416, especially if the next actions may involve a manufacturing issue. In yet another example, the framework system 100 may be used to answer questions from a user about the sounds that are captured by the sensors 416.

While many of the examples discussed herein relate to audio, the described techniques may also apply to other modalities alone or in parallel with the audio. As some examples, vibration sensors, accelerometers, and/or camera may be used to provide vibration, acceleration, and or image data, which may be processed into segments for embeddings and for the extraction of detailed characteristics from each segment. Additionally, the vibration, acceleration, and/or video may be linked with contextual metadata to provide the enhanced semantic augmentation.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuits (ASICs), field programmable gate arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc.

1. A method for searching enhanced representations of audio data to improve audio retrieval accuracy and precision, the method comprising:
segmenting a digital audio signal into a plurality of discrete time-based chunks of predefined length;
extracting features from each chunk to generate corresponding audio embeddings defined as vector representations of the digital audio signal;
storing the audio embeddings in a vector database for retrieval and similarity-based search;
processing the audio embeddings using an audio-language model guided by structured prompts of an insights template to generate characteristic metadata associated with corresponding time-based chunks of the digital audio signal, wherein the insights template includes a plurality of predefined metadata fields and the structured prompts instruct the audio-language model to populate the plurality of predefined metadata fields with the characteristic metadata corresponding to each corresponding time-based chunk;
storing the metadata in a relational database, wherein the audio embeddings are indexed by shared identifiers and the metadata is linked to the audio embeddings using the shared identifiers; and
performing a multimodal similarity-based search to locate chunks of the digital audio signal based on a combination of vector-based similarity scores from the vector database and keyword-based ranking of the metadata in the relational database.

2. The method of claim 1, further comprising:
receiving the audio signal comprising a sequence of audio samples; and
preprocessing the audio signal, including one or more of normalizing signal levels, resampling to a target rate, and trimming silences.

3. The method of claim 1, wherein the audio embeddings represent characteristics of the audio signal including at least one of pitch, tempo, spectral content, loudness, or background noise.

4. The method of claim 1, wherein the audio vectorization comprises applying one or more of Mel-Frequency Cepstral Coefficient (MFCC) extraction, a pretrained machine learning model for feature extraction, or spectrogram-based transformation including short-time Fourier transform (STFT) or Mel spectrogram.

5. The method of claim 1, wherein the audio-language model is trained on multimodal data and configured to analyze and classify non-verbal sounds, including environmental noises and machine sounds.

6. The method of claim 1, wherein the metadata generated by the audio-language model include at least one of classification of sound type, detection of periodic noise patterns, identification of anomalies based on deviations from expected embeddings, or environmental context interpretation.

7. The method of claim 1, further comprising using a soft prompt mechanism to prompt the audio-language model to incorporate high-level semantic evidence using event tags, such that the metadata includes the event tags matching the audio embeddings.

8. The method of claim 1, further comprising:
receiving a query including audio and keywords;
querying the vector database based on semantic similarity of the audio to determine matching results;
refining the results by querying the relational database based on the keywords; and
returning search results based on a combination of vector-based similarity scores and keyword-based ranking.

9. The method of claim 1, further comprising performing an anomaly detection by:
computing a similarity score between an input audio received from a manufacturing system and reference embeddings in the vector database;
determining a deviation threshold based on statistical measures of the reference embeddings;
classifying the input audio as anomalous if the similarity score falls outside the deviation threshold; and
controlling an actuator responsive to the input audio being classified as anomalous.

10. A system for searching enhanced semantic representations of audio data, the system comprising:
a vector database;
a relational database; and
one or more computing devices including at least one hardware processor and memory storing instructions executable by the at least one hardware processor, the one or more computing devices configured to:
segment a digital audio signal into a plurality of discrete time-based chunks of predefined length,
extract features from each chunk to generate corresponding audio embeddings defined as vector representations of the digital audio signal,
store the audio embeddings in the vector database for retrieval and similarity-based search,
process the audio embeddings using an audio-language model guided by structured prompts of an insights template to generate characteristic metadata associated with corresponding time-based chunks of the digital audio signal, wherein the insights template includes a plurality of predefined metadata fields and the structured prompts instruct the audio-language model to populate the plurality of predefined metadata fields with the characteristic metadata corresponding to each corresponding time-based chunk,
store the metadata in the relational database, wherein the audio embeddings are indexed by shared identifiers and the metadata is linked to the audio embeddings using the shared identifiers, and
perform a multimodal similarity-based search to locate chunks of the digital audio signal based on a combination of vector-based similarity scores from the vector database and keyword-based ranking of the metadata in the relational database.

11. The system of claim 10, wherein the one or more computing devices are further configured to:
receive the audio signal comprising a sequence of audio samples; and
preprocess the audio signal, including one or more of normalizing signal levels, resampling to a target rate, and trimming silences.

12. The system of claim 10, wherein the audio embeddings represent characteristics of the audio signal including at least one of pitch, tempo, spectral content, loudness, or background noise.

13. The system of claim 10, wherein the one or more computing devices are further configured to apply one or more of MFCC extraction, a pretrained machine learning model for feature extraction, or spectrogram-based transformation including STFT or Mel spectrogram.

14. The system of claim 10, wherein the audio-language model is trained on multimodal data and configured to analyze and classify non-verbal sounds, including environmental noises and machine sounds.

15. The system of claim 10, wherein the metadata generated by the audio-language model include at least one of classification of sound type, detection of periodic noise patterns, identification of anomalies based on deviations from expected embeddings, or environmental context interpretation.

16. The system of claim 10, wherein the one or more computing devices are further configured to use a soft prompt mechanism to prompt the audio-language model to incorporate high-level semantic evidence using event tags, such that the metadata includes the event tags matching the audio embeddings.

17. The system of claim 10, wherein the one or more computing devices are further configured to:
receive a query including audio and keywords;
query the vector database based on semantic similarity of the audio to determine matching results;
refine the results by querying the relational database based on the keywords; and
return search results based on a combination of vector-based similarity scores and keyword-based ranking.

18. The system of claim 10, wherein the one or more computing devices are further configured to perform an anomaly detection including to:
compute a similarity score between an input audio received from a manufacturing system and reference embeddings in the vector database;
determine a deviation threshold based on statistical measures of the reference embeddings;
classify the input audio as anomalous if the similarity score falls outside the deviation threshold; and
control an actuator responsive to the input audio being classified as anomalous.

19. A non-transitory computer-readable medium comprising instructions that, when executed by one or more computing devices, cause the one or more computing devices to perform operations including to:
segment a digital audio signal into a plurality of discrete time-based chunks of predefined length;
extract features from each chunk to generate corresponding audio embeddings defined as vector representations of the digital audio signal;
store the audio embeddings in a vector database for retrieval and similarity-based search;
process the audio embeddings using an audio-language model guided by structured prompts of an insights template to generate characteristic metadata associated with corresponding time-based chunks of the digital audio signal, wherein the insights template includes a plurality of predefined metadata fields and the structured prompts instruct the audio-language model to populate the plurality of predefined metadata fields with the characteristic metadata corresponding to each corresponding time-based chunk;
store the metadata in a relational database, wherein the audio embeddings are indexed by shared identifiers and the metadata is linked to the audio embeddings using the shared identifiers; and
perform a multimodal similarity-based search to locate chunks of the digital audio signal based on a combination of vector-based similarity scores from the vector database and keyword-based ranking of the metadata in the relational database.

20. The non-transitory computer-readable medium of claim 19, further comprising instructions that when executed by the one or more computing devices, cause the one or more computing devices to perform operations including to:
receive a query including audio and keywords;
query the vector database based on semantic similarity of the audio to determine matching results;
refine the results by querying the relational database based on the keywords; and
return search results based on a combination of vector-based similarity scores and keyword-based ranking.

21. The non-transitory computer-readable medium of claim 19, further comprising instructions that when executed by the one or more computing devices, cause the one or more computing devices to perform operations including to:
compute a similarity score between an input audio received from a manufacturing system and reference embeddings in the vector database;
determine a deviation threshold based on statistical measures of the reference embeddings;
classify the input audio as anomalous if the similarity score falls outside the deviation threshold; and
control an actuator responsive to the input audio being classified as anomalous.

22. The method of claim 1, wherein each of the audio embeddings is stored in association with a respective audio chunk identifier identifying a corresponding one of the plurality of discrete time-based chunks, the characteristic metadata is stored as relational records in the relational database, each relational record including the respective audio chunk identifier as a shared identifier that links the relational record to a corresponding audio embedding stored in the vector database, and performing the multimodal similarity-based search includes:
executing a vector similarity search against the vector database to generate the vector-based similarity scores;
executing a keyword query against the predefined metadata fields of the relational database to generate keyword-ranking scores; and
ranking the chunks based on a combination of the vector-based similarity scores and the keyword-ranking scores.
